(19) United States
(12) Patent Application Publication
(10) Pub. No.: US 2014/0090117 A1
(43) Pub. Date: Mar. 27, 2014

(54) MAGNETIC HEAD INSPECTION SYSTEM AND MAGNETIC HEAD INSPECTION METHOD

(71) Applicant: HITACHI HIGH-TECHNOLOGIES CORPORATION, Tokyo (JP)

(72) Inventors: Teruaki TOKUTOMI, Kamisato-machi (JP); Tsuneo NAKAGOMI, Kamisato-machi (JP); Akira TOBITA, Kamisato-machi (JP); Norimitsu MATSUSITA, Kamisato-machi (JP)

(73) Assignee: HITACHI HIGH-TECHNOLOGIES CORPORATION, Tokyo (JP)

(21) Appl. No.: 13/967,658

(22) Filed: Aug. 15, 2013

(30) Foreign Application Priority Data
Sep. 25, 2012 (JP) 2012-210491

(51) Int. Cl. G11B 5/455

(52) U.S. Cl. CPC G11B 5/455
USPC 850/9; 850/46; 850/25

(57) ABSTRACT

The magnetic head inspection method includes, exciting the cantilever of a magnetic force microscope at a predetermined frequency, the cantilever being provided with a magnetic probe on the end thereof, floating the magnetic probe over the writing head of the magnetic head and two-dimensionally scanning a search range, detecting the specific position of the writing head based on the search two-dimensional magnetic field intensity of the writing head with exciting state of the cantilever in the two-dimensional scan, setting a shape detection range smaller than the search range for detecting the shape of the writing head based on the specific position, and floating the magnetic probe over the writing head with exciting state of the cantilever, detecting the shape of the writing head by detecting the detection two-dimensional magnetic field intensity of the writing head in the two-dimensional scan.

### BACKGROUND OF THE INVENTION

The present invention relates to a magnetic head inspection system and a magnetic head inspection method for inspecting a thin film magnetic head, and particularly relates to a magnetic head inspection system and a magnetic head inspection method that allow an efficient inspection of a thin film magnetic head not testable by an optical microscope.

Japanese Patent Laid-Open No. 2009-230845 discloses a technique for inspecting the track width of a thin film magnetic head. In Japanese Patent Laid-Open No. 2009-230845, a recording signal (excitation signal) is inputted to a thin film magnetic head (hereinafter, will be simply referred to as a magnetic head) in a row bar from bonding pads, and a state of a magnetic field generated by a writing head element contained in the magnetic head is moved and scanned at a position as high as the flying height of the magnetic head. A direct observation under a magnetic force microscope (MFM), a scanning hall probe microscope (SHPM), or a scanning magneto-resistance microscope (SMRM) allows a measurement of the shape of the generated magnetic field instead of the physical shape of the writing head element, thereby it is possible to inspect a shape in a magnetic effective track width in a nondestructive manner.

Specifically, an effective track width testable by a spinstand only in an HGA state or pseudo-HGA state can be measured in a row bar under a magnetic force microscope.

### SUMMARY OF THE INVENTION

In order to correctly measure the shape of a magnetic head element of 100 nm or less, positioning is necessary for scanning a predetermined inspection range, for example, a current 1 μm square range. Thus, it is necessary to visually search a wide range under an optical microscope for the position of a magnetic head element, and then search a smaller scan range. For example, in the related art described in Japanese Patent Laid-Open No. 2009-230845, a first search range is visually searched, and then partial 10-μm square search ranges are sequentially set with respect to the central position (locations for rough positioning) of the first search range. The partial search ranges are then searched under an atomic force microscope (AFM). When a measuring object is found, a second search range smaller than the first search range, for example, 4 μm to 5 μm square range is set, and then the range is searched again under an MFM. When a measuring object is found as a result of searching, the current predetermined shape inspection range that is a 1 μm square range is scanned to determine the shape of the magnetic head element. In the related art, a scanning inspection requires a long time. An AFM inspection time particularly needs to be shortened.

The purpose of the present invention is to provide a magnetic head inspection system and a magnetic head inspection method that allow an efficient inspection of a magnetic head by shortening a scanning inspection time.

The features of the present invention are at least followings in order to achieve the above described purpose.

The present invention includes, exciting the cantilever of a magnetic force microscope at a predetermined frequency, the cantilever being provided with a magnetic probe on the end thereof, floating the magnetic probe over the writing head of the magnetic head and two-dimensionally scanning a search range, detecting the specific position of the writing head based on the search two-dimensional magnetic field intensity of the writing head with exciting state of the cantilever in the two-dimensional scan, setting a shape detection range smaller than the search range for detecting the shape of the writing head based on the specific position, and floating the magnetic probe over the writing head with exciting state of the cantilever, detecting the shape of the writing head by detecting the detection two-dimensional magnetic field intensity of the writing head in the two-dimensional scan.

According to the present invention, the specific position may indicate maximum magnetic field intensity of the search two-dimensional magnetic field intensity.

According to the present invention, the magnetic head may be imaged and the search range may be set according to the imaging result.

According to the present invention, the magnetic head may be visually observed with an optical microscope and the search range may be obtained by moving an inspection stage for loading the row bar based on the visual observation information.

According to the present invention, the shape of the writing head may be inspected by using the cantilever based on the shape detection range under an atomic force microscope.

The present invention can provide a magnetic head inspection system and a magnetic head inspection method that can efficiently inspect the magnetic head.

### BRIEF DESCRIPTION OF THE DRAWINGS

Embodiments of the present invention will be described in detail based on the following figures, wherein:

FIG. 1 schematically illustrates the configuration of a magnetic head inspection system according to a first embodiment of the present invention.

FIGS. 2A and 2B show the outline of the inspection method of the magnetic head inspection system illustrated in FIG. 1.

FIG. 3 shows the shape and search range of a magnetic head element.

FIG. 4 shows an image of the contour lines of magnetic field intensity when a predetermined range containing the writing head of a magnetic head is entirely scanned.

FIGS. 5A and 5B schematically show line magnetic field intensity profiles for respective line scans when the overall range of FIG. 4 is scanned.

FIG. 6 is a graph of an effective line magnetic field intensity profile, in which the writing head is most likely to have a magnetic effective track width, out of line magnetic field intensity profiles obtained by line scanning on the magnetic head in FIG. 4.

FIG. 7 shows a process of measuring the shape of the writing head by a controller according to the first embodiment.

FIG. 8 schematically illustrates the configuration of a magnetic head inspection system according to a second embodiment of the present invention.

### DESCRIPTION OF THE PREFERRED EMBODIMENTS

### First Embodiment

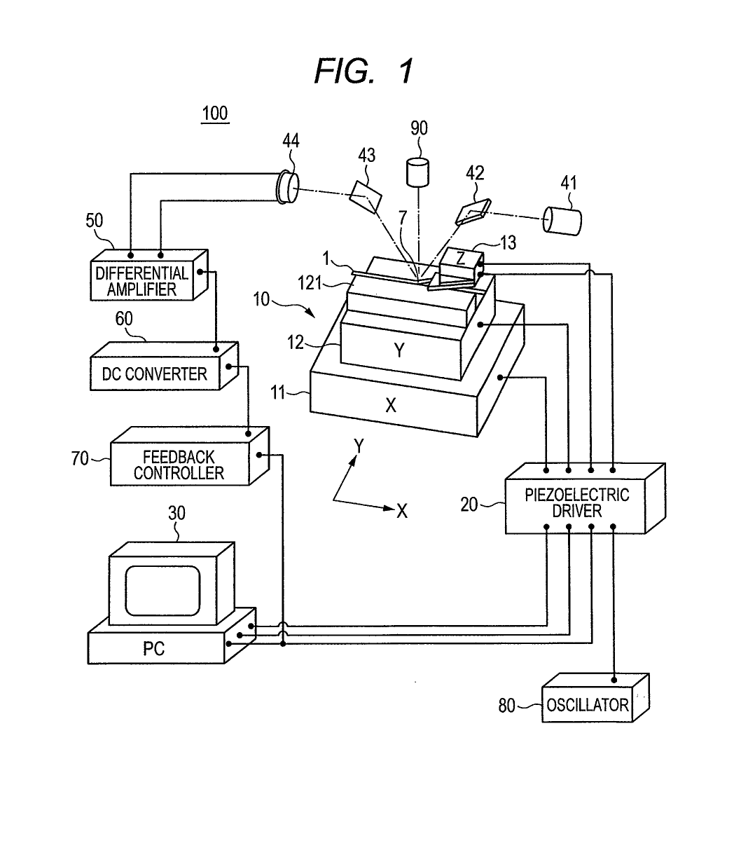

FIG. 1 schematically illustrates the configuration of a magnetic head inspection system 100 according to a first embodiment of the present invention. The magnetic head inspection system 100 can measure the magnetic effective track width of a writing head HW, e.g., an MR head, a GMR head, and a TMR head (hereinafter, will be referred to as a magnetic head H) in a row bar (a block containing an array of head sliders) before sliders (chips) are cut.

Typically, a row bar cut into a long block of about 3 cm to 7 cm from a wafer contains an array of about 40 to 60 head sliders. The magnetic head inspection system of the present embodiment conducts a predetermined inspection on a row bar 1 serving as a work. About 20 to 30 row bars 1 are typically accommodated at predetermined intervals in a tray (not shown) in the short axis direction of the row bar 1. The row bars 1 are picked out one by one from the tray (not shown) and then are transported to an inspection stage 10 by a handling robot (not shown). The row bar 1 transported to the inspection stage 10 is inspected as will be described later.

The inspection stage 10 includes an X stage 11 and a Y stage 12 that can move the row bar 1 in X and Y directions. The row bar 1 is positioned by once bringing one side of the row bar 1 into contact with the reference surface of the Y stage 12 in the long axis direction of the row bar 1. The top surface of the Y stage 12 has a loading part 121 for the row bar 1. The side edge of the top surface of the loading part 121 has a step portion substantially matching with the shape of the row bar 1. The row bar 1 coming into contact with the bottom and the side of the step portion is located at a predetermined position. The rear side of the row bar 1 (the opposite side from the connection terminals of the magnetic head) is brought into contact with the rear surface of the step portion. The contact surface has a reference plane in parallel with and perpendicularly to the moving direction (X axis) of the X stage 11 and the moving direction (Z axis) of a Z stage 13. Thus, the row bar 1 in contact with the bottom and the side of the step portion of the Y stage 12 is positioned in the X direction and the Y direction.

A camera (not shown) for measuring a misalignment is provided above the Y stage 12. The Z stage 13 moves a cantilever 7 of a magnetic force microscope (MFM) in the Z direction. The X stage 11, the Y stage 12, and the Z stage 13 of the inspection stage 10 are each composed of a piezoelectric stage. After the completion of the predetermined positioning, the row bar 1 is sucked and held by the loading part 121 such that the probe end of a probe card (not shown) comes into contact with a terminal on the front side of the row bar 1. Hence, the writing head coil of a magnetic head in the row bar 1 can be excited.

A piezoelectric driver 20 controls the driving of the X stage 11, the Y stage 12, and the Z stage 13 (piezoelectric stage) of the inspection stage 10. A controller 30 for controlling the piezoelectric driver 20 includes a control computer basically composed of a personal computer (PC) having a monitor. As shown in FIG. 1, the cantilever 7 having a pointed magnetic probe on the free end is located above the row bar 1 placed on the Y stage 12 of the inspection stage 10. The cantilever 7 is attached to an excitation member provided under the Z stage 13. The excitation member includes a piezoelectric element. The excitation member receives an alternating voltage having a frequency around a mechanical resonance frequency in response to an excitation voltage from the piezoelectric driver 20, vibrating the magnetic probe in a vertical direction.

A displacement detector includes a semiconductor laser element 41, reflecting mirrors 42 and 43, and a displacement sensor 44 composed of a half-split light detector element. Outgoing light from the semiconductor laser element 41 is reflected by the reflecting mirror 42, is emitted onto the cantilever 7, and then is reflected toward the reflecting mirror 43. The light reflected by the cantilever 7 is further reflected by the reflecting mirror 43 and then is guided to the displacement sensor 44. A differential amplifier 50 performs predetermined arithmetic processing on a differential signal of two signals outputted from the displacement sensor 44 and then outputs the processed differential signal to a DC converter 60. In other words, the differential amplifier 50 outputs a displacement signal to the DC converter 60 according to a difference between the two signals outputted from the displacement sensor 44. The DC converter 60 includes an RMS-DC converter (Root Mean Squared value to Direct Current converter) that converts the displacement signal outputted from the differential amplifier 50 into a direct current signal having an effective value.

The displacement signal outputted from the differential amplifier 50 corresponds to a displacement of the cantilever 7. The displacement signal serves as an alternating current signal because of the vibrations of the cantilever 7. A signal from the DC converter 60 is outputted to a feedback controller 70. The feedback controller 70 outputs the signal from the DC converter 60 to the controller 30 as a signal for monitoring the amplitude of the current vibrations of the cantilever 7, and outputs the signal from the DC converter 60 to the piezoelectric driver 20 as a control signal of the Z stage 13 for adjusting the excitation of the cantilever 7.

The controller 30 monitors the signal and controls the Z stage 13 of the piezoelectric driver 20 according to the value of the signal, adjusting the initial position of the cantilever 7 before the start of measurement. In the present embodiment, the flying height of the head of a hard disk drive is set as the initial position of the cantilever 7. The controller performs processing for obtaining the magnetic effective track width of a magnetic head based on data obtained from the feedback controller 70. The flying height of the cantilever is preferably equal to the flying height of the head but may have a deviation. In the case of such a deviation, the obtained magnetic effective track width is corrected according to the height.

An oscillator 80 supplies an oscillation signal for exciting the cantilever 7 to the piezoelectric driver 20. The piezoelectric driver 20 vibrates the cantilever 7 at a predetermined frequency based on the oscillation signal from the oscillator 80.

An optical microscope 90 detects the position of the magnetic head in the row bar 1 set on the inspection stage 10.

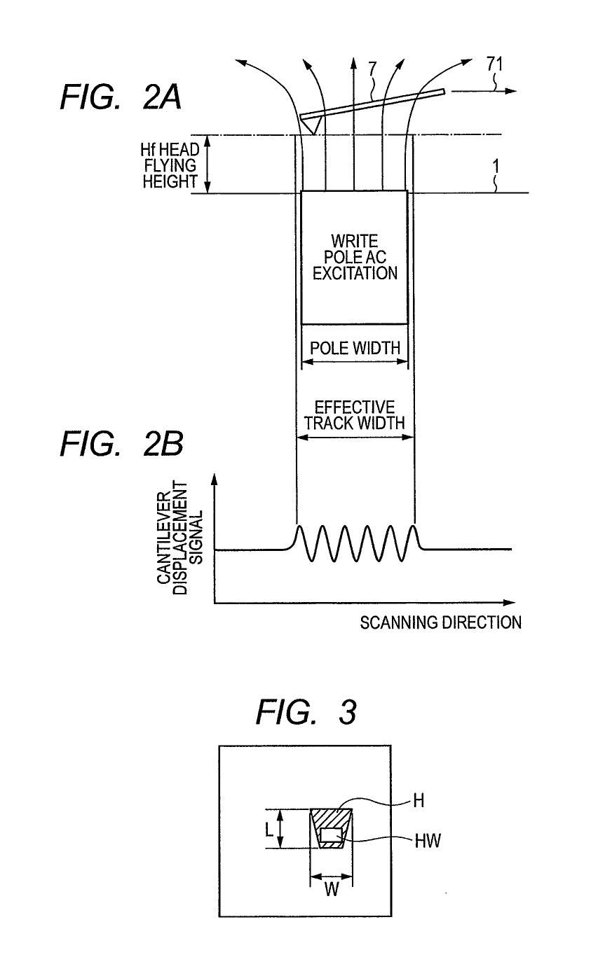

FIGS. 2A and 2B show the outline of the inspection method of the magnetic head inspection system illustrated in FIG. 1. FIG. 2A is an enlarged view of the configuration of the magnetic head. FIG. 2B shows an example of the displacement signal of the cantilever. As illustrated in FIG. 2A, the cantilever 7 is positioned by the Z stage 13 so as to locate the tip end of the magnetic probe of the cantilever 7 as high as a head flying height Hf from the surface of the magnetic head formed in the row bar 1. The cantilever 7 is scanned in a scanning direction 71 relative to the row bar 1 (magnetic head) . In the present embodiment, the row bar 1 is moved by the X stage 11 and the Y stage 12.

At this point, the writing head of the magnetic head has undergone AC excitation, thereby displacing the cantilever 7 in synchronization with the AC excitation. The displaced state of the cantilever 7 is indicated by the displacement signal shown in FIG. 2B, Thus, the effective track width of the magnetic head can be detected by detecting the displacement signal. The writing head is inspected by typical MFM without AC excitation, allowing actual measurement of the pole width of the magnetic head element.

With this configuration, vibrations at the predetermined frequency of the cantilever 7 cause a phase difference proportional to the intensity of a magnetic field generated by the magnetic head, and cause a difference between the two signals outputted from the displacement sensor 44 having the half-split light detector element according to the phase difference. Hence, the intensity of the magnetic field from the magnetic head is determined according to the difference between the two signals. In this state, the writing head of the magnetic head undergoes AC excitation, meanwhile, the effective track width of the magnetic head can be obtained by scanning the magnetic head as will be described later. The writing head is inspected as typical MFM without AC excitation, allowing actual measurement of the pole width (structural magnetic width) of the magnetic head. In the present invention, the writing head is inspected with AC excitation under an MFM that is not a typical MFM.

FIG. 3 shows the shape and search range of a magnetic head element HS. A magnetic head H in FIG. 3 has a width W and a length L that are 100 nm or less.

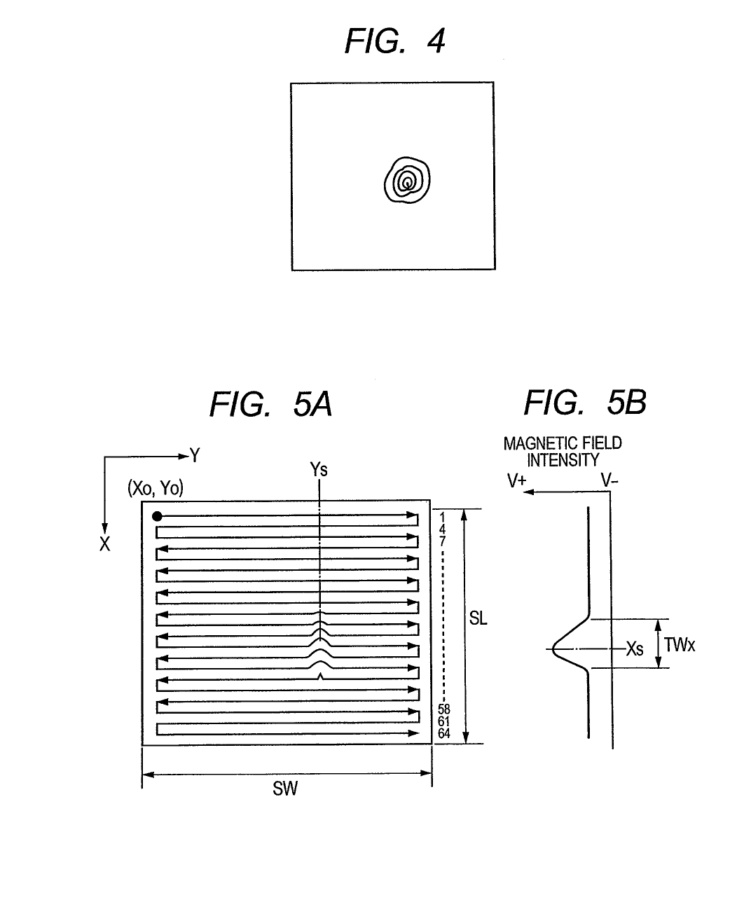

FIG. 4 shows an image of the contour lines of magnetic field intensity when a predetermined range containing a writing head HW of the magnetic head is entirely scanned. In two-dimensional scanning, as shown in FIGS. 5A and 5B described later, line scanning is performed in Y direction across the magnetic head in parallel with the short side of the row bar 1. After scanning, shift scanning is performed at predetermined intervals in the X direction along the long side of the row bar 1. These operations are repeatedly performed. In FIG. 4, a white part surrounding the image is not affected by the AC excited magnetic field of the head HW while the part of the contour lines is affected by the AC excited magnetic field. The influence of the magnetic field increases toward the center of the range, that is, the magnetic field of the writing head HW increases toward the center of the range. The image in three dimensions is shaped like a cone having a gradually expanding outer surface.

FIGS. 5A and 5B schematically show line magnetic field intensity profiles for respective line scans during scanning over the range of FIG. 4. FIG. 5A shows the line magnetic field intensity profiles. FIG. 5B shows a maximum magnetic field intensity profile formed by a maximum value of each of the line magnetic field intensity profiles . Vertically arranged numbers in FIG. 5A are line scan numbers. Reference character SL denotes the width of a shape detection range or a search range in the long side (X) direction of the row bar. Reference character SW denotes the width of the shape detection range or the search range in the short side (Y) direction of the row bar.

As shown in FIG. 5A, the line magnetic field intensity profiles in the upper part of FIG. 5A are substantially flat profiles not affected by the magnetic field of the writing head HW and are followed by an affected region that is gradually expanded. A line scan is obtained with a maximum magnetic field in FIG. 4 by the writing head HW, and then the magnetic field decreases, after that, become a flat profile again in a region not affected by the magnetic field. FIG. 5B show a maximum magnetic field intensity profile formed by the maximum value of each of the line magnetic field intensity profiles. The maximum magnetic field intensity profile gradually peaks around a scan having a maximum magnetic field obtained by the writing head HW.

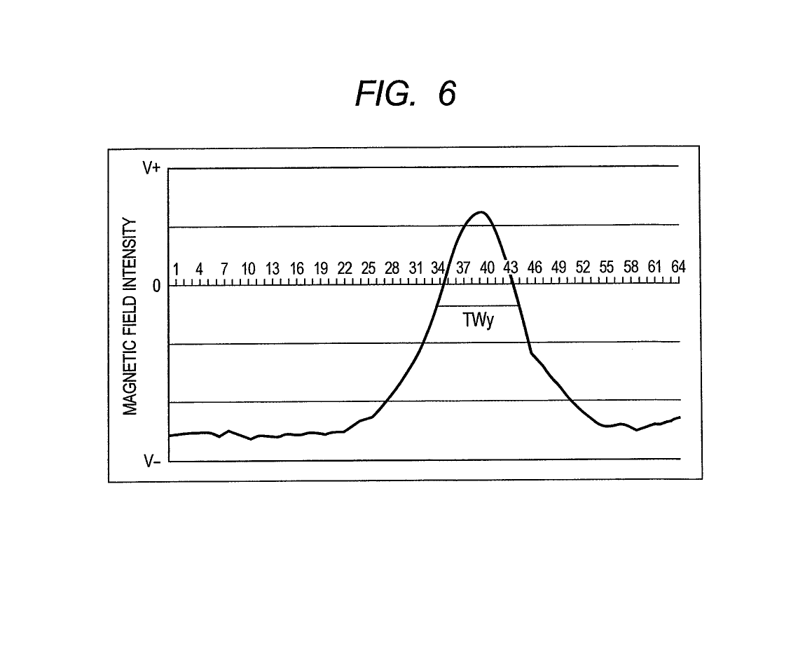

FIG. 6 is a graph of a line scan image obtained as a line magnetic field intensity profile by scanning the magnetic head in a lateral (Y) direction in FIG. 4. In other words, FIG. 6 shows an effective line magnetic field profile out of the line magnetic field intensity profiles such that the influence of the magnetic field of the magnetic head may cause a maximum width, that is, the writing head is most likely to have a magnetic effective track width. The horizontal axis indicates scanning positions while the vertical axis indicates an output voltage value (V) of the DC converter 60 according to the magnetic field intensity of the magnetic head at each of the scanning positions.

In the present embodiment, as shown in FIG. 6, a level width having at least certain magnetic intensity is defined as a magnetic effective track width TW to detect the magnetic shape of the writing head. The effective track width TW in FIG. 6 is an effective track width TWy in the short side (Y) direction of the row bar 1 while the effective track width TW in FIG. 5B is an effective track width TWx in the short side (X) direction of the row bar 1. The sign of the output voltage value (V) of the DC converter 60 may be reversed depending upon the measuring conditions.

However, as described in Summary of The Invention, it takes a long time to locate the position of the writing head HW in a predetermined detection range (e.g., width(SW)=length(SL)=1 μm in FIG. 4).

In the first embodiment, the scanning range is searched by an MFM instead of an AFM. In an MFM search, a maximum magnetic field detection position (Xs, Ys) is detected so as to indicate the maximum value of the effective line magnetic field intensity profile in which the writing head HW is likely to have a magnetic effective track width as shown in FIGS. 5A and 5B. The scan range is reduced according to the position of the maximum value. (Xo, Yo) indicates the start position of line scanning.

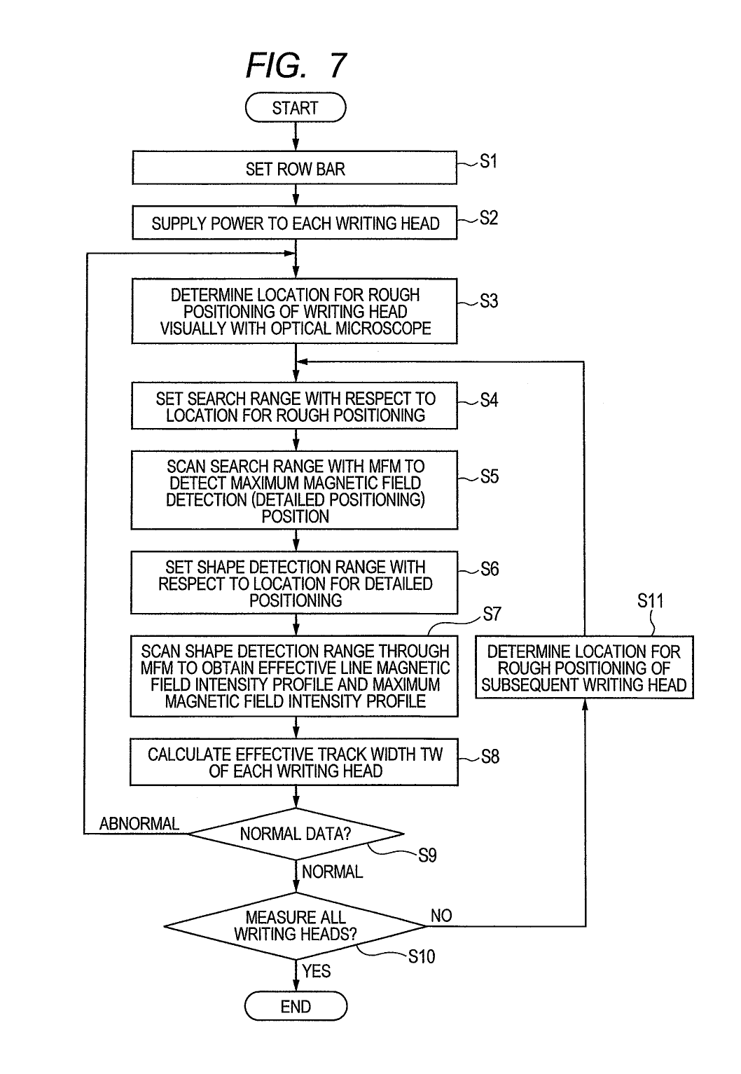

FIG. 7 shows a process of measuring the shape of the writing head HW by the controller 30 according to the first embodiment. First, the row bar 1 is set on the loading part 121 for positioning (S1). Power is supplied to the writing head HW in the row bar 1 (S2), the writing head HW is visually observed under the optical microscope 30, the inspection stage 10 is manually controlled, and then a location for rough positioning of the writing head is obtained as the center position of the search range (S3).

Subsequently, a search range is set for a search around the location for rough positioning (S4). A search time for an MFM is quite shorter than a search time for an AFM. Thus, in order to minimize a detection time under an AFM, first, an initial partial search range of about 10 μm square is set around the location for rough positioning, and then partial search ranges are sequentially set around the initial partial search range. The ranges are searched until a test object is found. For example, for an MFM, a search range of about 20 μm square is set and then the overall range is searched for a maximum magnetic field detection position, that is, a location for detailed positioning (S5).

Subsequently, a shape detection range for inspecting the shape of the writing head, for example, a 1-um square range is set around the location for detailed positioning (S6). The shape detection range is scanned under an MFM to obtain an effective line magnetic field intensity profile andamaximummagnetic field intensityprofile (S7). The effective track widths TWy and TWx in FIG. 6 and FIG. 5B are then obtained according to the effective line magnetic field intensity profile and the maximum magnetic field intensity profile to calculate the shape of the writing head (S8).

Subsequently, it is decided whether the values of the obtained effective track widths TWy and TWx are within a normal range or not (S9). If the values are not normal, the process returns to S3. If the values are normal, it is decided whether all the writing heads in the row bar 1 have been inspected or not (S10). If the writing heads have been inspected, the processing is ended. Otherwise a location for rough positioning is calculated for the subsequent writing head HW at a predetermined distance (S11) , and then the process is continued from S4.

The first embodiment can reduce a processing time from 3 minutes or more to 5 seconds or less for an AFM, remarkably shortening the processing time.

Moreover, the first embodiment can reduce the conventional number of searches from two to one, achieving simple processing.

### Second Embodiment

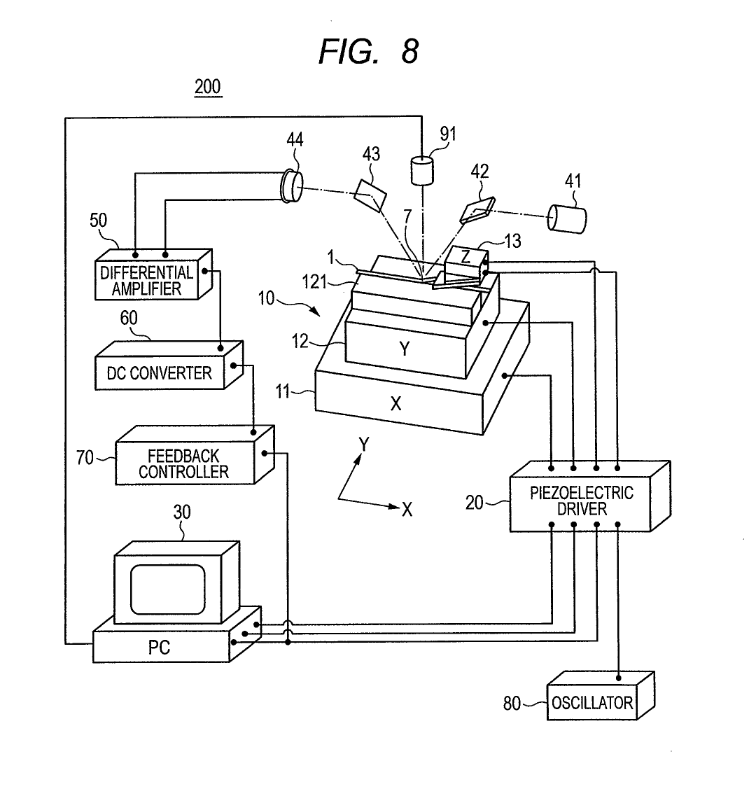

In a second embodiment, a location for rough positioning is detected from an imaging result of a magnetic head H captured by an imaging camera 91 unlike in the first embodiment in which a location for rough positioning is determined by visual observation under an optical microscope. FIG. 8 schematically illustrates the configuration of a magnetic head inspection system 200 according to the second embodiment of the present invention. The magnetic head inspection system 200 is different from the magnetic head inspection system 100 of the first embodiment in that the imaging camera 91 is provided and a controller 30 includes a data processor for detecting the position of the magnetic head H having a writing head HW based on an imaging result of the imaging camera 91.

A process of measuring the shape of the writing head HW according to the second embodiment is different from the first embodiment in that “through visual observation under an optical microscope” in step S3 of determining a location for rough positioning of the writing head in FIG. 7 is replaced with “based on an imaging result obtained by the imaging camera”. Other points of processing are identical to those of the first embodiment.

The process of measuring the shape of the writing head HW according to the second embodiment is different from the contents of the first embodiment. First, the accuracy for detecting the location for rough positioning by the imaging camera 91 is improved, thereby reducing the search range in S4. This can shorten a search time.

Since the accuracy for detecting the location for rough positioning is improved, the rate of abnormal data in S9 dramatically decreases so as to more reliably inspect the magnetic head H (writing head HW).

Moreover, the second embodiment can achieve a fully automatic inspection and thus more reliably inspect the magnetic head H (writing head HW).

In the second embodiment, a location for rough positioning is detected by the imaging camera 91 with higher accuracy. Thus, the process may skip the processing of S11 in FIG. 7 and directly advance to S3 so as to detect a location for rough positioning on each magnetic head.

In the first and second embodiments, a location for rough positioning and a location for detailed positioning are set at the maximum magnetic field detection position of the writing head. These locations are not limited and thus may be set at other positions, e.g., the median of the writing head and a position indicating the end of the writing head.

In the first and second embodiments, when an AFM inspection is conducted by a different control method of the cantilever after an MFM inspection, the AFM can use data includes a location determined for detailed positioning (maximum magnetic field detection position) under an MFM. This can reduce the inspection range and an AFM inspection time.

It should be understood by those skilled in the art that various modifications, combinations, sub-combinations and alterations may occur depending on design requirements and other factors insofar as they are within the scope of the appended claims or the equivalents thereof.

What is claimed is:

1. A magnetic head inspection system comprising:
a cantilever of a magnetic force microscope including a magnetic probe on the tip and oscillated at a predetermined frequency;
a search scan controller floating the magnetic probe over the writing head so as to conduct a search two-dimensional scan on a search range in parallel with one side of a writing head of the magnetic head;
a search detector detecting search two-dimensional magnetic field intensity of the writing head, the magnetic field intensity indicating an excited state of the cantilever in the search two-dimensional scan;
a position detector detecting a specific position of the writing head based on the search two-dimensional magnetic field intensity;
a shape detection range setting device setting a shape detection range for detecting a shape of the writing head based on the specific position, the shape detection range being smaller than the search range;
a detection scan controller floating the magnetic probe over the writing head so as to conduct a detected shape two-dimensional scan on the shape detection range in parallel with one side of the magnetic head;
a detected shape detector detecting detection two-dimensional magnetic field intensity of the writing head in the detected shape two-dimensional scan, the two-dimensional magnetic field intensity indicating an excited state of the cantilever, and
a shape detector detecting the shape of the writing head by using the detection two-dimensional magnetic field intensity.

2. The magnetic head inspection system according to claim 1, wherein the specific position is a position of maximum magnetic field intensity of the search two-dimensional magnetic field intensity.

3. The magnetic head inspection system according to claim 1, further comprising an imaging device imaging the magnetic head, wherein the search range is set based on a result of the imaging.

4. The magnetic head inspection system according to claim 2, further comprising an imaging device imaging the magnetic head, wherein the search range is set based on a result of the imaging.

5. The magnetic head inspection system according to claim 1, further comprising:
an optical microscope for visual observation of the magnetic head; and
an inspection stage for loading and movement of the row bar,
wherein the search range is obtained by moving the inspection stage based on the visual observation information.

6. The magnetic head inspection system according to claim 2, further comprising:
an optical microscope for visual observation of the magnetic head, and
an inspection stage for loading and movement of the row bar,
wherein the search range is obtained by moving the inspection stage based on the visual observation information.

7. The magnetic head inspection system according to claim 1, wherein the writing head undergoes a shape inspection by means of the cantilever under an atomic force microscope based on the shape detection range.

8. The magnetic head inspection system according to claim 2, wherein the writing head undergoes a shape inspection by means of the cantilever under an atomic force microscope based on the shape detection range.

9. The magnetic head inspection system according to claim 3, wherein the writing head undergoes a shape inspection by means of the cantilever under an atomic force microscope based on the shape detection range.

10. The magnetic head inspection system according to claim 5, wherein the writing head undergoes a shape inspection by means of the cantilever under an atomic force microscope based on the shape detection range.

11. A magnetic head inspection method comprising:
exciting a cantilever of a magnetic force microscope at a predetermined frequency, the cantilever being provided with a magnetic probe on an end thereof;
floating the magnetic probe over a writing head of a magnetic head and conducting a search two-dimensional scan on a search range in parallel with one side of the writing head;
detecting search two-dimensional magnetic field intensity of the writing head during the search two-dimensional scan, the magnetic field intensity indicating an excited state of the cantilever;
detecting a specific position of the writing head based on the search two-dimensional magnetic field intensity;
setting a shape detection range for detecting a shape of the writing head based on the specific position, the shape detection range being smaller than the search range;
floating the magnetic probe over the writing head and conducting a detected shape two-dimensional scan on the shape detection range in parallel with one side of the writing head;
detecting detection two-dimensional magnetic field intensity of the writing head in the detected shape two-dimensional scan, the magnetic field intensity indicating the excited state of the cantilever, and
detecting the shape of the writing head by using the detection two-dimensional magnetic field intensity.

12. The magnetic head inspection method according to claim 11, wherein the specific position is a position of maximum magnetic field intensity of the search two-dimensional magnetic field intensity.

13. The magnetic head inspection method according to claim 11, wherein the magnetic head is imaged, and the search range is set based on a result of the imaging.

14. The magnetic head inspection method according to claim 12, wherein the magnetic head is imaged, and the search range is set based on a result of the imaging.

15. The magnetic head inspection method according to claim 11, further comprising:
visually observing the magnetic head under an optical microscope,
wherein the search range is obtained by moving an inspection stage for loading of the row bar based on the visual observation information.

16. The magnetic head inspection method according to claim 12, further comprising:
visually observing the magnetic head under an optical microscope,
wherein the search range is obtained by moving an inspection stage for loading of the row bar based on the visual observation information.

17. The magnetic head inspection method according to claim 11, further comprising inspecting the shape of the writing head by means of the cantilever under an atomic force microscope based on the shape detection range.

18. The magnetic head inspection method according to claim 12, further comprising inspecting the shape of the writing head by means of the cantilever under an atomic force microscope based on the shape detection range.

19. The magnetic head inspection method according to claim 13, further comprising inspecting the shape of the writing head by means of the cantilever under an atomic force microscope based on the shape detection range.

20. The magnetic head inspection method according to claim 15, further comprising inspecting the shape of the writing head by means of the cantilever under an atomic force microscope based on the shape detection range.
